(19) United States
(12) Patent Application Publication
(10) Pub. No.: US 2009/0218868 A1
(43) Pub. Date: Sep. 3, 2009

(54) SEAT LIFTING APPARATUS

(75) Inventors: Yoshitaka KOGA, Chiryu-shi (JP); Eiichiro Tsuji, Anjo-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 12/372,122

(22) Filed: Feb. 17, 2009

(30) Foreign Application Priority Data
Feb. 29, 2008 (JP) 2008-049981

(51) Int. Cl. B60N 2/16

(52) U.S. Cl. 297/344.17

(57) ABSTRACT

A seat lifting apparatus includes a seat cushion frame pivotally moving about a pivot center provided at a lower frame, a driven gear having a first end portion engaged with a driving gear connected to a driving mechanism, a pivotal link member provided between a second end portion of the driven gear and the seat cushion frame for absorbing a deviation between a locus of the second end portion of the driven gear and an arc-shaped locus of the seat cushion frame, and a side frame plate pivotally supported by the lower arm about the pivot center for supporting the seat cushion frame and including a sidewall portion arranged to be parallel with an operational plane of the driven gear and the pivotal link member. The pivotal link member and the side surface portion of the side frame plate are engaged with each other at plural portions.

### CROSS REFERENCE TO RELATED APPLICATIONS

This application is based on and claims priority under 35 U.S.C. §119 to Japanese Patent Application 2008-049981, filed on Feb. 29, 2008, the entire content of which is incorporated herein by reference.

### FIELD OF THE INVENTION

The present invention generally relates to a seat lifting apparatus.

### BACKGROUND

A known seat apparatus for a vehicle includes a seat lifting apparatus for adjusting a height-position of a seat in response to a physique and preference of an occupant seated thereon. JP1993-7077Y (hereinafter, referred to as reference 1) discloses such seat lifting apparatus as an example. According to the reference 1, the seat lifting apparatus includes a lifting shaft, a sector gear and a driving gear. The lifting shaft is employed for upwardly and downwardly moving one of a base frame (a fixture member) and a seat frame (a movable member) relative to the other one of the base frame and the seat frame. The sector gear (serving as a driven gear) is fixed to the lifting shaft. The driving gear is supported by the base frame via a shaft member so as to engage with the sector gear (the driven gear) and is rotatably driven by a rotational operating mechanism. An engagement supporting portion for preventing the sector gear from disengaging from the driving gear is formed to cover a side surface of an engagement portion between the sector gear and the driving gear. Still further, a shaft hole, through which the lifting shaft is inserted via a bush member, is formed at one of the base frame and the seat frame. A diameter of the shaft hole is arranged to be larger than a diameter of the lifting shaft by a length of an overlapping portion between the engagement supporting portion and the sector gear.

Further, JP1994-65069U (hereinafter, referred to as reference 2) discloses a seat lifting apparatus, which includes a pinion gear and a sector gear (driven gear) engaged with the pinion gear as a torque-transmitting unit. According to the reference 2, an arc-shaped groove portion is formed at the sector gear (the driven gear) so as to have a rotational shaft of the sector gear as a center of the arc-shaped portion. The pinion gear is fitted into the arc-shaped groove portion. A toothed portion, which is to be engaged with the pinion gear, is formed at an inner circumferential surface of the groove portion. Further, an outer circumferential surface of the groove portion makes contact with the pinion gear, thereby restraining a movement of the pinion gear in a direction to be away from a center of the sector gear. Thus, a distance between the center of the pinion gear and the center of the sector gear is maintained in a range where the pinion gear and the sector gear are allowed to rotatably move relative to each other.

According to the seat lifting apparatuses disclosed in the references 1 and 2, a pivot link (a connection link) is provided in order to absorb a deviation between an arc-shaped locus of a cushion-side member (including a seat cushion), on which a front side portion of the seat cushion moves in an upper-lower direction by being pivotally supported at a rear side portion thereof, and an arc-shaped locus of a link member, on which the link member moves by being pivotally supported at a front side portion thereof so as to transmit a driving torque for moving the seat cushion in the upper-lower directions. The pivot link (the connection link) is connected between the seat cushion and the link member so as to be relatively rotatable thereto by caulking such as by means of a pin as an example, and a slight backlash is generated at a connected portion of the pivot link. Further, lack in rigidity of the link member in a lateral direction of the seat cushion occurs. Still further, although the reduction of the number of components structuring the seat lifting apparatus has been required, the reduction of the number of components may be difficult because such pivot link is pivotally supported by caulking by means of the separately-provided pin.

A need thus exists for a seat lifting apparatus, which is not susceptible to the drawback mentioned above.

### SUMMARY OF THE INVENTION

According to an aspect of the present invention, a seat lifting apparatus includes a seat cushion frame, a driven gear, a pivotal link member and a side frame plate. The seat cushion frame is pivotally upwardly and downwardly moves about a pivot center provided at a lower frame. The driven gear has a first end portion engaged with a driving gear connected to a driving mechanism. The pivotal link member is provided between a second end portion of the driven gear and the seat cushion frame for absorbing a deviation between a locus of the second end portion of the driven gear and an arc-shaped locus of the seat cushion frame. The side frame plate is pivotally supported by the lower arm about the pivot center provided at the lower frame for supporting the seat cushion frame. The side frame plate including a sidewall portion arranged to be parallel with an operational plane of the driven gear and the pivotal link member. The pivotal link member and the side surface portion of the side frame plate are engaged with each other at plural portions.

### BRIEF DESCRIPTION OF THE DRAWINGS

The foregoing and additional features and characteristics of the present invention will become more apparent from the following detailed description considered with reference to the accompanying drawings, wherein:

FIG. 1 is a side view schematically illustrating a seat lifting apparatus according to an embodiment of the present invention;

FIG. 2 is a side view illustrating the seat lifting apparatus;

FIG. 3 is an exploded view illustrating the seat lifting apparatus;

FIG. 4 is a partial view schematically illustrating an assembling condition of a pivotal link member of the seat lifting apparatus according to a modified embodiment;

FIG. 5 is a partial view schematically illustrating an assembling condition of the pivotal link member of the seat lifting apparatus according to the embodiment;

FIG. 6 is an explanatory view illustrating an operational condition of the seat lifting apparatus; and

FIG. 7 is a schematic view illustrating a snap-fit structure of the seat lifting apparatus.

### DETAILED DESCRIPTION

An embodiment of the present invention will be described hereinafter with reference to the attached drawings. Directions, such as “front-rear (longitudinal)”, “right-left (lateral)”, “upper-lower (vertical)”, and the like, correspond to the orientation of a vehicle to which a seat lifting apparatus 20 according to the embodiment is adapted.

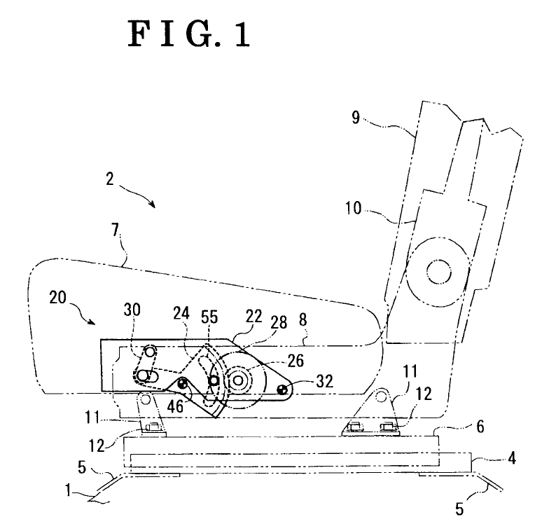

As illustrated in FIG. 1, a seat apparatus 2 is mainly structured with left and right lower rails 4 of a seat slide apparatus, left and right upper rails 6 of the seat slide apparatus, left and right lower arms 8 onto which a seat cushion 7 is assembled, left and right upper arms 10 onto which a seat back 9 is assembled, and left and right seat lifting apparatuses (each serving as a seat lifting apparatus) 20.

More specifically, the lower rails 4 are provided on a floor 1 of the vehicle so as to extend in the longitudinal direction of the vehicle by means of brackets 5, respectively. The upper rails 6 are slidably mounted on the lower rails 4, respectively. A relative sliding movement between the lower rails 4 and the corresponding upper rails 6 of the seat slide apparatus is locked and unlocked by a lock-unlock mechanism The lower arms (each serving as a lower frame) 8 are provided at upper portions of the corresponding upper rails 6 via brackets 11 and connecting members 12 (bolts and nuts), respectively. Further, the upper arms 10, onto which the seatback 9 is assembled, are provided at rear upper portions of the corresponding lower arms 8 so as to be pivotable relative to the lower arms 8 via a reclining mechanism. Hereinafter, the description refers only one of the right and left sides of the seat apparatus 2 (for example, the right side of the seat apparatus 2) as an example of each of the right and left sides of the seat apparatus 2, unless otherwise indicated.

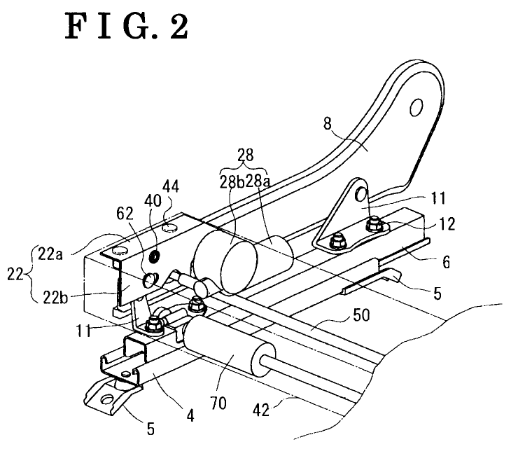

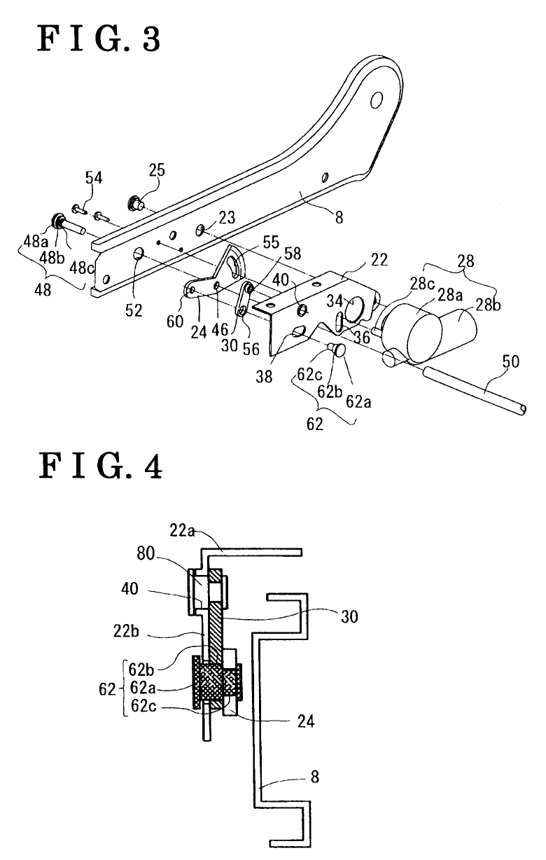

The seat lifting apparatus 20 is provided at a front portion of the lower arms 8. The seat lifting apparatus 20 is structured with a side frame plate 22, a sector gear (serving as a driven gear) 24, a pinion gear (serving as a driving gear) 26, a driving motor mechanism (serving as a driving mechanism) 28 and a pivotal link member 30. The pinion gear 26 is engaged with an arc-shaped outer tooth portion formed at a first end portion of the sector gear 24. The driving motor mechanism 28 is employed for driving the pinion gear 26. The pivotal link member 30 is connected to a second end portion of the sector gear 24. The side frame plate 22 is made from a metallic material, for example, and is bent to form an upper wall portion 22a and a sidewall portion 22b, as illustrated in FIG. 2. Further, a pivot center hole 32 (hereinafter, referred to as a pivot center 32) is formed at a rear end portion of the sidewall portion 22b of the side frame plate 22 (see FIG. 1). The sidewall portion 22b of the side frame plate 22 is supported at an inner side surface of the lower arm 8 (serving as a lower frame) so as to be pivotally movable relative to the lower arm 8 about the pivot center 32. Further, as illustrated in FIG. 3, the sidewall portion 22b of the side frame plate 22 includes a through hole 34, an elongated hole portion 36, a loose shaft hole 38 and a shaft hole 40. The pinion gear 26 of the driving motor mechanism 28 is inserted through the through hole 34. A supporting rod member (described below) for fixing the driving motor mechanism 28 to the lower arm 8 is inserted through the elongated hole portion 36. The loose shaft hole (serving as a hole and as an elongated hole) 38 extends in forward and backward directions of the seat lifting apparatus 20, i.e., in forward and backward directions of the side frame plate 22. A connected portion between the second end portion of the sector gear 24 and a first end portion of the pivotal link member 30, i.e., the connected portion at which the link member 30 and the sector gear 24 are relatively pivotably connected, is engaged with the shaft hole 38 so as to be loosely movable within the shaft hole 38. A second end portion of the pivotal link member 30 is engaged with the shaft hole 40. More specifically, a circumferential engagement protruding portion 58 (described below in detail) is formed at the second end portion of the pivotal link member 30, while a boss portion is formed at the shaft hole 40 of the sidewall portion 22b so as to protrude therefrom by a burring process. The circumferential engagement protruding portion 58 of the pivotal link member 30 fits into the shaft hole 40 in a manner where a circumferential surface of the circumferential engagement protruding portion 58 contacts the boss portion of the shaft hole 40, thereby a rotational axis of the circumferential engagement protruding portion 58 of the pivotal link member 30 will not be out of alignment.

As illustrated in FIG. 2, a front panel 42 is fixed to the upper wall portion 22a of the side frame plate 22 by means of a connecting member 44 such as a rivet, for example. The front panel 42 serves as a cushion frame fixed to a lower surface of the seat cushion 7.

A rotational center hole 46 is formed at a central portion of the sector gear 24. The arc-shaped outer tooth portion is formed at the first end portion of the sector gear 24. Further, an operational hole 60 is defined (pierced) at the second end portion of the sector gear 24. The operational hole 60 of the sector gear 24 is connected to the pivotal link member 30, which will be described below in detail. A fixation screw (an external thread member) 48 is relatively unrotatably assembled to the rotational center hole 46. More specifically, the fixation screw 48 includes a collar portion 48a, a circumferential slidable portion 48b and a serration portion 48c, which are formed sequentially from a base end portion of the fixation screw 48 towards the lower plate 8 (see FIG. 3). The serration portion 48c of the fixation screw 48 is relatively unrotatably connected to the rotational center hole 46 formed at the sector gear 24. Further, the serration portion 48c of the fixation screw 48 is fitted into an end portion of a torque transmitting rod 50. The torque transmitting rod 50 transmits the driving torque from the driving motor mechanism 28 to the left seat lifting apparatus 20, for example, which is structured with a lifting link member formed at another end portion of the torque transmitting rod 50, a left pivotal link member 30, and a left side frame plate 22. The circumferential slidable portion 48b of the fixation screw 48 is pivotably supported to an attachment hole 52 formed at the lower arm 8. The arc-shaped outer tooth portion of the sector gear 24 is engaged with the pinion gear 26 of the driving motor mechanism 28. The driving motor mechanism 28 includes a motor 28a and a reduction device 28b. The reduction device 28b reduces the torque of the motor 28a by means of a worm gear so as to transmit the torque to the pinion gear 26. The driving motor mechanism 28 includes plural supporting portions 28c (two supporting portions 28c are provided, according to the embodiment). Each of the supporting portions 28c protrudes from a side portion of the driving motor mechanism 28 in the lateral direction of the vehicle and includes an internal thread portion. The driving motor mechanism 28 is fixed to the lower arm 8 via the supporting portions 28c and plural external thread members 54, which are inserted into the internal thread portions of the supporting portions 28c, respectively. A guide groove 55 is formed at the sector gear 24. The guide groove 55 extends along the arc-shaped outer tooth portion of the sector gear 24. The supporting portions 28c of the driving motor mechanism 28 are fitted into the groove portion 55 of the sector gear 24, thereby guiding a movement of the sector gear 24.

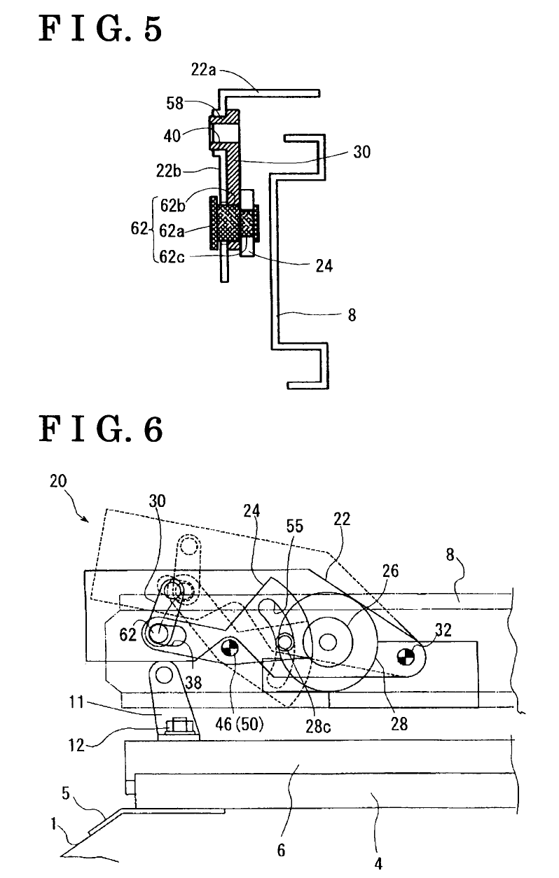

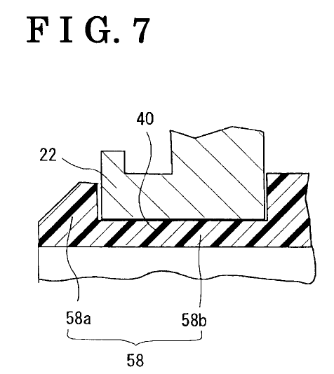

The pivotal link member 30 is an elongated plate member, which is formed by a known hard resin material having abrasion resistance and high elasticity. In other words, the pivotal link member is made from a material of which rigidity is lower than that of the material for the side frame plate 22. The pivotal link member 30 includes a connecting hole 56 at the first end portion thereof and the circumferential engagement protruding portion 58, which functions as a snap-fit structure, at the second end portion thereof (see FIG. 7). A pivotal movement supporting member 62 is inserted into the connecting hole 56 and the, operational hole 60 defined at the second end portion of the sector gear 24 so as to be relatively rotatable thereto. The pivotal movement supporting member 62 includes a collar portion 62a, a first circumferential slidable portion 62b and a second circumferential slidable portion 62c, which are formed sequentially from a base end portion of the pivotal movement supporting member 62 in the lateral direction. An outer diameter of the second circumferential slidable portion 62c is smaller than an outer diameter of the first circumferential slidable portion 62b. The first circumferential slidable portion 62b is inserted through the loose shaft hole 38 of the side frame plate 22 and the connecting hole 56 of the pivotal link member 30, and the second circumferential portion 62c is inserted through the operational hole 60 of the sector gear 24 and is connected thereto by caulking (see FIG. 5). The pivotal link member 30 and the sector gear 24 are engaged with each other at the connected portion structured with the connecting hole 56 of the link member 30 and the operational hole 60 of the sector gear 24 so as to be relatively pivotable due to a play generated between the loose shaft hole 38 formed at the side frame 22 and the pivotal movement supporting member 62. Further, the pivotal link member 30 and the side frame plate 22 are supported between the collar portion 62a of the pivotal movement supporting member 62 and the sector gear 24 by being interposed therebetween. The circumferential engagement protruding portion 58, which is formed at the second end portion of the pivotal link member 30, is inserted into and pivotably engaged with the shaft hole 40 of the side frame plate 22. As illustrated in FIGS. 5 and 7, the circumferential engagement protruding portion 58 of the pivotal link member 30 includes plural cantilever beams, which are aligned in a circumferential direction of the circumferential engagement protruding portion 58. Each of the cantilever beams includes a hook portion 58a, and an elastic portion 58b. More specifically, each hook portion 58a is formed at an end portion of the corresponding cantilever beam, and each elastic portion 58b is formed at a base portion of the corresponding cantilever beam, i.e., the elastic portion 58b of each cantilever beam extends from a surface of the pivotal link member 30, and the hook portion 58a is formed at an end portion of the corresponding elastic portion 58b. The hook portion 58a includes a tapered portion, which has an inclined surface inclining from an end of the hook portion 58a towards the end portion of the elastic portion 58b so that a cross sectional thickness thereof is reduced to be smaller towards the end of the hook portion 58a. Further, a circumferential portion of the circumferential engagement protruding portion 58 is structured with the elastic portions 58b of the cantilever beams, which are aligned in the circumferential direction thereof, and is fitted into the shaft hole 40 of the side frame plate 22. When inserting the circumferential engagement protruding portion 58 into the shaft hole 40 of the side frame plate 22, the inclined surface of each hook portion 58a guides the elastic portion 58b to be elastically deformed in a radially inner direction of the shaft hole 40. Then, after the hook portion 58a passes through the shaft hole 40, the hook portion 58a of each of the cantilever beams moves radially outwardly by an elastic force of the elastic portion 58b and engages a rim of the shaft hole 40.

As shown in FIG. 2, a driving mechanism 70 for the seat slide apparatus is provided at the upper rail 6 of the seat slide apparatus. The driving mechanism 70 mainly includes a screw shaft, a nut member, a gear unit, a torque reduction gear unit and a motor device. The upper rail 6 slidably moves in the longitudinal direction relative to the lower rail 4 by the torque (driving force) of the motor device of the driving mechanism 70.

An operation of the seat apparatus 2 structured as described above will be described hereinbelow. For example, when upwardly moving the seat cushion 7, the motor 28a of the driving motor mechanism 28 is actuated, and the driving force (torque) of the motor 28a is transmitted to the pinion gear 26 via the reduction device 28b, thereby rotating the pinion gear 26. Then, the first end portion of the sector gear 24, which is engaged with the outer tooth portion of the pinion gear 26 by the rotation thereof, pivotally moves in the clockwise direction in FIG. 6 (i.e., downwardly moves), thereby upwardly moving the second end portion of the sector gear 24. The pivotal link member 30, which is relatively movably connected to the second end portion of the sector gear 24, pivotally moves upwardly in accordance with the pivotal movement of the sector gear 24. At this time, because the second end portion of the sector gear 24 and the first end portion of the pivotal link member 30 are engaged with each other at the loose shaft hole 38 of the side fame plate 22 via the pivotal movement supporting member 62, the side frame plate 22 also pivotally moves upwardly in cooperation with the pivotal movement of the pivotal link member 30. However, the side frame plate 22 pivots about the pivot center 32 provided at the lower arm 8. The second end portion of the pivotal link member 30 is fitted into the shaft hole 40 formed at the side frame plate 22. Then, as illustrated in FIG. 6, a distance from the pivot center hole 46 of the sector gear 24 to the pivotal link member 30 is increased in accordance with an increase of an angle formed between the sector gear 24 and the pivotal link member 30, and the increase of the angle formed between the pivotal link member 30 and the sector gear 24 absorbs a deviation between a locus of the sector gear 24 pivotally moving about the pivot center hole 46 and a locus of the side frame plate 22 pivotally moving about the pivot center 32. The side frame plate 22 upwardly moves the front panel 42 fixed at the upper wall portion 22a of the side frame plate 22. Because the front panel 42 is further fixed to the lower surface of the seat S cushion 7, a front side portion of the seat cushion 7 pivotally moves upwardly about the pivot center 32 formed at the lower arm 8. Further, by the driving torque transmitted from the torque transmitting rod 50, the other seat lifting apparatus 20 (the left seat lifting apparatus 20), which is structured with the left lifting link member, the left pivotal link member 30 and the left side frame plate 22, are operated in the same manner as described. Thus, the left and right seat lifting apparatuses 2 are synchronously operated, thereby upwardly moving the seat cushion 7.

Thus, according to the seat lifting apparatus 20, the first end portion of the pivotal link member 30 is engaged with the side frame plate 22 along with the second end portion of the sector gear 24. Further, the second end portion of the pivotal link member 30 is engaged with the shaft hole 40 of the side frame plate 22. Therefore, a moment applied to the pivotal link member 30 in the lateral direction of the seat is supported by the side frame plate 22. Accordingly, high rigidity of the seat lifting apparatus 20 is assured without forming the pivotal link member 30 and the connected portion which is structured with the first end portion of the pivotal link member 30 and the second end portion of the sector gear 24 by a material with high rigidity.

Further, because the pivotal link member 30 may not necessarily be formed of such material with high rigidity, the pivotal link member 30 is formed of a resin material, which can be processed at low cost. Then, because such resin material is employed for the pivotal link member 30, a pivotal shaft portion (such as the circumferential engagement protruding portion 58) of the link member 30, which is to be assembled to the side frame plate 22, for example, is integrally formed at the pivotal link member 30. Therefore, a pin member for assembling the pivotal link member 30 to the side frame plate 22 may be omitted without separately providing the same, thereby reducing the number of components of the seat lifting apparatus 20. Further, the pivotal link member 30 is assembled onto the side frame plate 22 by the snap-fit structure. Therefore, an assembling process of the seat lifting apparatus 20 can be rapidly executed, thereby improving the productivity of the seat lifting apparatus 20.

Still further, although the moment in the lateral direction is generated the largest at the connected portion structured with the first end portion of the link member 30 and the second end portion of the sector gear 24, the connected portion is supported by the side frame plate 22 by being engaged with the loose shaft hole 38 formed at the side frame plate 22. Therefore, such connected portion is highly effectively reinforced by the side frame plate 22. Still further, because the connected portion between the pivotal link member 30 and the sector gear 24 pivotally moves, the angle formed between the pivotal link member 30 and the sector gear 24 is flexibly changed with a small movement. Accordingly, the seat lifting apparatus 20 can be downsized.

According to the embodiment described above, the sector gear 24 is employed as the driven gear. Alternatively, the worm gear, which is engaged with the pinion gear 26 connected to the driving motor mechanism 28 and is operated to move in accordance with the rotation of the pinion gear 26, may be employed as the driven gear.

Further according to the embodiment, the circumferential engagement protruding portion 58 is provided at the pivotal link member 30 and is fitted into the shaft hole 40 so that the pivotal link member 30 is assembled onto the side frame plate 22. Alternatively, as illustrated in FIG. 4, a pin member 80 made of metal may be inserted through the pivotal link member 30 and the shaft hole 40 of the side frame plate 22 and fixed by caulking.

Still further according to the embodiment, the pivotal link member 30 is engaged with the side frame plate 22 at the loose shaft hole 38 and the shaft hole 40 formed at the side frame plate 22. Alternatively, another engagement protruding portion may be formed at a central portion of the pivotal link member 30 while another pivot hole may be formed at the side frame plate 22, as an example. Thus, the pivotal link member 30 may be engaged with the side frame plate 22 via more than three portions.

Due to the above described structure, because the pivotal link member 30 is engaged with the side frame plate 22 at more than two portions, the moment, which is generated in the lateral direction (i.e., in a direction being perpendicular to an operational plane of the sector gear 24 and the pivotal link member 30) when the torque is transmitted from the sector gear 24, may be supported by the side frame plate 22. Therefore, high rigidity of the seat lifting apparatus 20 is assured without forming the pivotal link member 30 and the connected portion between the pivotal link member 30 and the sector gear 24 by a material with high rigidity.

Further according to the embodiment, the loose shaft hole 38 is formed at the sidewall portion 22b of the side frame plate 22. The first end potion of the pivotal link member 30 and the second end portion of the sector gear 24 are relatively rotatably connected with each other. The connected portion between the first end portion of the pivotal link member 30 and the second end portion of the driven gear is connected to the lose shaft hole 38 of the side frame plate so as to be movable within the loose shaft hole 38.

Further, the loose shaft hole 38 formed at the sidewall portion 22b of the side frame plate 22 is formed in an elongated shape.

Still further, the loose shaft hole 38 extends in the forward and backward directions of the seat lifting apparatus 20.

Due to the above described structure, although the moment in the lateral direction is generated the largest at the connected portion structured with the first end portion of the link member 30 and the second end portion of the sector gear 24, the connected portion is supported by the side frame plate 22 by being engaged with the loose shaft hole 38 formed at the side frame plate 22. Therefore, the connected portion is highly effectively reinforced by the side frame plate 22. Still further, because the connected portion between the pivotal link member 30 and the sector gear 24 pivotally moves, the angle formed between the pivotal link member 30 and the sector gear 24 is flexibly changed with a small movement. Accordingly, the seat lifting apparatus 20 can be downsized.

Further according to the embodiment, the pivotal link member 30 is made from a material of which rigidity is lower than that of a material for the side frame plate 22.

More specifically, the pivotal link member 30 is made from a resin material.

Further, the side frame plate 22 is made from a metallic material.

Due to the above described structure, the pivotal link member 30 may not necessarily be made from the material with high rigidity. Alternatively, the pivotal link member 30 is made from the resin material, which is produced with low cost. Further, because the resin material is employed for producing the pivotal link member 30, a pin member for assembling the pivotal link member 30 to the side frame plate 22 may be omitted without separately providing such pin, thereby reducing the number of components of the seat lifting apparatus 20.

Still further according to the embodiment, the pivotal link member 30 includes the snap-fit structure. Further, the pivotal link member 30 is assembled to the sector gear 24 and the side frame plate 22 through the snap-fit structure.

Due to the above described structure, because the pivotal link member 30 is assembled to the sector gear 24 and to the side frame plate 22 by the snap-fit structure, an assembling process may be rapidly executed, thereby improving the productivity of the seat lifting apparatus 20.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat lifting apparatus, comprising:
a seat cushion frame pivotally upwardly and downwardly moving about a pivot center provided at a lower frame;
a driven gear having a first end portion engaged with a driving gear connected to a driving mechanism;
a pivotal link member provided between a second end portion of the driven gear and the seat cushion frame for absorbing a deviation between a locus of the second end portion of the driven gear and an arc-shaped locus of the seat cushion frame; and
a side frame plate pivotally supported by the lower arm about the pivot center provided at the lower frame for supporting the seat cushion frame, the side frame plate including a sidewall portion arranged to be parallel with an operational plane of the driven gear and the pivotal link member,
wherein the pivotal link member and the side surface portion of the side frame plate are engaged with each other at plural portions.

2. A seat lifting apparatus according to claim 1, wherein
a hole is formed at the sidewall portion of the side frame plate,
a first end portion of the pivotal link member and the second end portion of the driven gear are relatively rotatably connected with each other, and
a connected portion between the first end portion of the pivotal link member and the second end portion of the driven gear is connected to the hole of the side frame plate so as to be movable within the hole.

3. A seat lifting apparatus, according to claim 2, wherein
the hole formed at the sidewall portion includes an elongated shape.

4. A seat lifting apparatus, according to claim 3, wherein
the hole formed at the sidewall portion extends in forward and backward directions of the seat lifting apparatus.

5. A seat lifting apparatus according to claim 1, wherein
the pivotal link member is made from a material of which rigidity is lower than that of a material for the side frame plate.

6. A seat lifting apparatus, according to claim 5, wherein
the pivotal link member is made from a resin material.

7. A seat lifting apparatus according to claim 5, wherein
the side frame plate is made from a metallic material.

8. A seat lifting apparatus according to claim 5, wherein
the pivotal link member includes a snap-fit structure, and
the pivotal link member is assembled to the driven gear and the side frame plate through the snap-fit structure.

9. A seat lifting apparatus according to claim 1, wherein
an elongated hole extending in forward and backward directions of the seat lifting apparatus is formed at the sidewall portion of the side frame,
a first end portion of the pivotal link member and the second end portion of the driven gear are relatively rotatably connected with each other, and
a connected portion between the first end portion of the pivotal link member and the second end portion of the driven gear is connected to the elongated hole of the side frame plate so as to be movable within the elongated hole.

10. A seat lifting apparatus according to claim 9, wherein
the pivotal link member is made from a material of which rigidity is lower than that of a material for the side frame plate.

11. A seat lifting apparatus according to claim 10, wherein
the pivotal link member is formed by a resin material.

12. A seat lifting apparatus according to claim 10, wherein
the side frame plate is formed by a metallic material.

13. A seat lifting apparatus according to claim 10, wherein
the pivotal link member includes a snap-fit structure, and
the pivotal link member is assembled to the driven gear and the side frame plate through the snap-fit structure.
